(19) United States
(12) Patent Application Publication
(10) Pub. No.: US 2010/0114706 A1
(43) Pub. Date: May 6, 2010

(54) Linked Hierarchical Advertisements

(75) Inventor: Yekesa S. Kosuru, Westford, MA (US)

Correspondence Address: DITTHAVONG MORI & STEINER, P.C., 918 Prince Street, Alexandria, VA, 22314, US

(73) Assignee: NOKIA CORPORATION, Espoo (FI)

(21) Appl. No.: 12/264,530

(22) Filed: Nov. 4, 2008

(51) Int. Cl. G06Q 30/00

(52) U.S. Cl. 705/14.55; 705/14.66

(57) ABSTRACT

A computing device may receive a request for a first advertisement. The request for the first advertisement may include one or more parameters referencing a given subject matter. Responsive to the request for the first advertisement, a first ad may be selected and delivered to a requesting entity. The computing device may receive an indication of an expression of interest in the first ad. The expression of interest may include one or more parameters referencing the first ad. Responsive to the expression of interest, and based on the one or more parameters referencing the first ad, a second, child ad may be selected and delivered to the requesting entity.

### FIELD

Aspects of the invention generally relate to computer networking, advertisement delivery, and follow-up advertisements. More specifically, an apparatus, method and system are described that provide a hierarchical structure of advertisements, wherein the advertisements may be delivered to a computing device based on one or more filtering mechanisms.

### BACKGROUND

Improvements in computing technologies have changed the way people accomplish various tasks. For example, some estimates indicate that between the years 1996 and 2007, the fraction of the world's population that uses the Internet grew from approximately 1% to approximately 22%. Irrespective of the actual percentages, trends suggest that the Internet will continue to grow.

Along with the growth of the Internet, users and service providers have developed numerous applications and corresponding interfaces to facilitate the exchange of information. Manufacturers and advertisers use the Internet to distribute product information and advertisements to targeted audiences. For example, a website directed to automobiles may initially present information listing the different makes or models that are produced by a manufacturer. A user may be able to obtain additional information about a given make or model by clicking (with a mouse) a pictorial representation of the make or model. Thereafter the user may be provided with additional details, such as the manufacturer's suggested retail price (MSRP), engineering specifications, and an ability to customize the make or model (e.g., an ability to virtually design one's own car).

### BRIEF SUMMARY

The following presents a simplified summary of example aspects of the invention in order to provide a basic understanding of some aspects of the invention. This summary is not an extensive overview, and is not intended to identify key or critical elements or to delineate the scope of the claims. The following summary merely presents some example concepts and aspects in a simplified form as a prelude to the more detailed description provided below.

To overcome limitations in the prior art described above, and to overcome other limitations that will be apparent upon reading and understanding the present specification, aspects of the present disclosure are directed to an apparatus, method and system for providing advertisements.

Various example aspects of the disclosure may, alone or in combination with each other, relate to receiving a request for a first advertisement, selecting the first advertisement, and delivering the first advertisement. Other various aspects may relate to receiving a request for a second advertisement based on the delivered first advertisement, selecting the second advertisement, and delivering the second advertisement.

These and other example aspects of the invention generally relate to a hierarchical arrangement of advertisements that may provide for a targeted and efficient sequence of delivery and presentation. The hierarchical arrangement may be established via one or more links. The one or more links may create a relationship between the advertisements and may be used to select a next advertisement to deliver to a user responsive to the user expressing interest in a preceding advertisement. A sequence in which the advertisements are to be delivered may be established at a time that the advertisements are created or defined. Alternatively, the sequence may be dictated by one or more targeting parameters. The targeting parameters may include data and/or metadata.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a network computing environment suitable for carrying out one or more example aspects of the invention.

FIG. 2 illustrates a data processing architecture suitable for carrying out one or more example aspects of the invention.

FIGS. 3A-3B illustrate a hierarchical data structure suitable for demonstrating one or more example aspects of the invention.

FIGS. 4A-4C illustrate a method and use case suitable for demonstrating a delivery of advertisements in accordance with one or more example aspects of the invention.

FIG. 5 illustrates a sequence diagram suitable for demonstrating one or more example aspects of the invention.

### DETAILED DESCRIPTION

In the following description of the various example embodiments, reference is made to the accompanying drawings, which form a part hereof, and in which is shown by way of illustration various embodiments in which one or more example aspects of the invention may be practiced. It is to be understood that other embodiments may be utilized and structural and functional modifications may be made without departing from the scope of the present invention.

Conventional advertising attempts to present product or service related information to a target audience. By way of introduction, and as demonstrated herein, example aspects of the invention may enhance the presentation of advertisements by following-up a baseline advertisement with one or more hierarchically linked advertisements. The linkage of the one or more advertisements may be based on one or more criteria or filtering mechanisms, whereby the selection of a second or child advertisement is based on some criterion, e.g., user location.

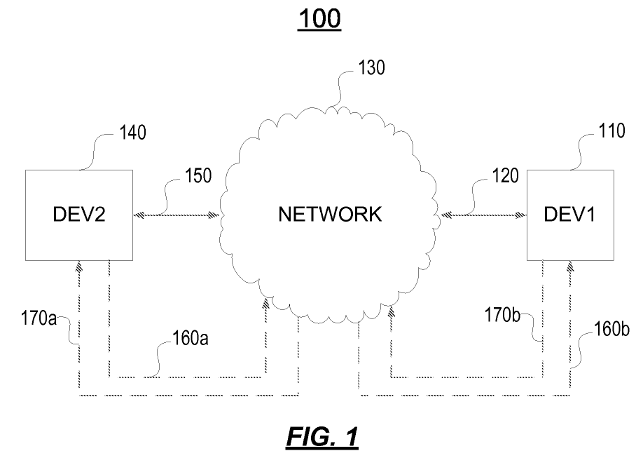

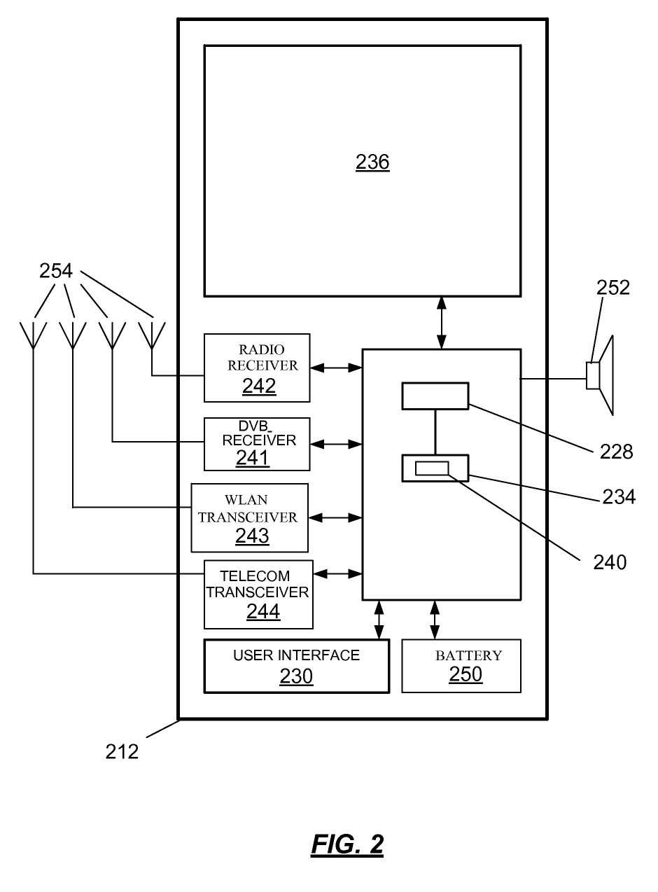

FIG. 1 illustrates a network computing environment 100 suitable for carrying out one or more example aspects of the present invention. For example, FIG. 1 illustrates a first computing device DEV1 110, e.g., device 212, FIG. 2, connected to a network 130 via a connection 120. Network 130 may include the Internet, an intranet, wired or wireless networks, or any other mechanism suitable for facilitating communication between computing platforms in general. FIG. 1 also depicts a second computing device DEV2 140, e.g., a computer, server, etc. connected to network 130 via a connection 150. By virtue of the connectivity as shown, DEV1 110 and DEV2 140 may communicate with one another. Such communications may enable the exchange of various types of information. For example, the communications may include data to be exchanged between DEV1 110 and DEV2 140. Such data may include media, images, audio, video, music, maps, games, programs, files, and/or the like. The communications may further include additional information such as control information.

Connections 120 and 150 illustrate interconnections for communication purposes. The actual connections represented by connections 120 and 150 may be embodied in various forms. For example, connections 120 and 150 may be hardwired/wireline connections. Alternatively, connections 120 and 150 may be wireless connections. Connections 120 and 150 are shown in FIG. 1 as supporting bi-directional communications (via the dual arrow heads on each of connections 120 and 150). Alternatively, or additionally, computing environment 100 may be structured to support separate forward (160a and 160b ) and reverse (170a and 170b ) channel connections to facilitate the communication.

Computing environment 100 may be carried out as part of a larger network consisting of more than two devices. For example, DEV2 140 may exchange communications with a plurality of other devices (not shown) in addition to DEV1 1 10. The communications may be conducted using one or more communication protocols. Furthermore, computing environment 100 may include one or more intermediary nodes (not shown) that may buffer, store, and/or route communications between the various devices.

FIG. 2, one example embodiment of the invention, illustrates a generic wireless or landline computing device 212, e.g., a desktop computer, laptop computer, notebook computer, network server, portable computing device, personal digital assistant, smart phone, mobile telephone, cellular telephone, user terminal, distributed computing network device, mobile media device, digital camera/camcorder, audio/video player, positioning device, game device, television receiver, radio receiver, digital video recorder, any other device having the requisite components or abilities to operate as described herein, or any combination thereof. As shown in FIG. 2, device 212 may include processor 228 connected to user interface 230, memory 234 and/or other storage, and display 236. Device 212 may also include battery 250, speaker 252 and antennas 254. User interface 230 may further include a keypad, touch screen, voice interface, four arrow keys, joy-stick, stylus, data glove, mouse, roller ball, touch screen, or the like. In addition, user interface 230 may include the entirety of or portion of display 236.

Computer executable instructions and data used by processor 228 and other components within device 212 may be stored in a computer readable memory 234. The memory may be implemented with any combination of read only memory modules or random access memory modules, optionally including both volatile and nonvolatile memory. Software 240 may be stored within memory 234 and/or storage to provide instructions to processor 228 for enabling device 212 to perform various functions. Alternatively, some or all of the computer executable instructions may be embodied in hardware or firmware (not shown).

Furthermore, the computing device 212 may include additional hardware, software and/or firmware to support one or more aspects of the invention as described herein. Device 212 may be configured to receive, decode and process digital broadcast transmissions that are based, for example, on the Digital Video Broadcast (DVB) standard, such as DVB-H, DVB-T or DVB-MHP, MediaFLO, Digital Multimedia Broadcasting (DMB), through a specific receiver 241. Digital Audio Broadcasting/Digital Multimedia Broadcasting (DAB/DMB) may also be used to convey television, video, radio, and data. The mobile device may also include other types of receivers for digital broadband broadcast transmissions. Additionally, device 212 may also be configured to receive, decode and process transmissions through FM/AM Radio receiver 242, wireless local area network (WLAN) transceiver 243, and telecommunications transceiver 244. In at least one embodiment of the invention, device 212 may receive radio data stream (RDS) messages.

Device 212 may use computer program product implementations including a series of computer instructions fixed either on a tangible medium, such as a computer readable storage medium (e.g., a diskette, CD-ROM, ROM, DVD, fixed disk, etc.) or transmittable to computer device 212, via a modem or other interface device, such as a communications adapter connected to a network over a medium, which is either tangible (e.g., optical or analog communication lines) or implemented wirelessly (e.g., microwave, infrared, radio, or other transmission techniques). The series of computer instructions may embody all or part of the functionality with respect to the computer system, and can be written in a number of programming languages for use with many different computer architectures and/or operating systems. The computer instructions may be stored in any memory device (e.g., memory 234), such as a semiconductor, magnetic, optical, or other memory device, and may be transmitted using any communications technology, such as optical infrared, microwave, or other transmission technology. The computer instructions may be operative on data that may be stored on the same computer readable medium as the computer instructions, or the data may be stored on a different computer readable medium. Moreover, the data may take on any form of organization, such as a data structure. Such a computer program product may be distributed as a removable storage medium with accompanying printed or electronic documentation (e.g., shrink wrapped software), preloaded with a computer system (e.g., on system ROM or fixed disk), or distributed from a server or electronic bulletin board over a network (e.g., the Internet or World Wide Web). Various embodiments of the invention may also be implemented as hardware, firmware or any combination of software (e.g., a computer program product), hardware and firmware. Moreover, the functionality as depicted may be located on a single physical computing entity, or may be divided between multiple computing entities.

In at least one embodiment, device 212 may include a mobile client implemented in a C-based, Java-based, Python-based, Flash-based or any other programming language for the Nokia® S60/S40 platform, or in Linux for the Nokia® Internet Tablets, such as N800 and N810, and/or other implementations. Device 212 may communicate with one or more servers over Wi-Fi, GSM, 3G, or other types of wired and/or wireless connections. Mobile and non-mobile operating systems (OS) may be used, such as Windows Mobile®, Palm® OS, Windows Vista® and the like. Other mobile and non-mobile devices and/or operating systems may also be used.

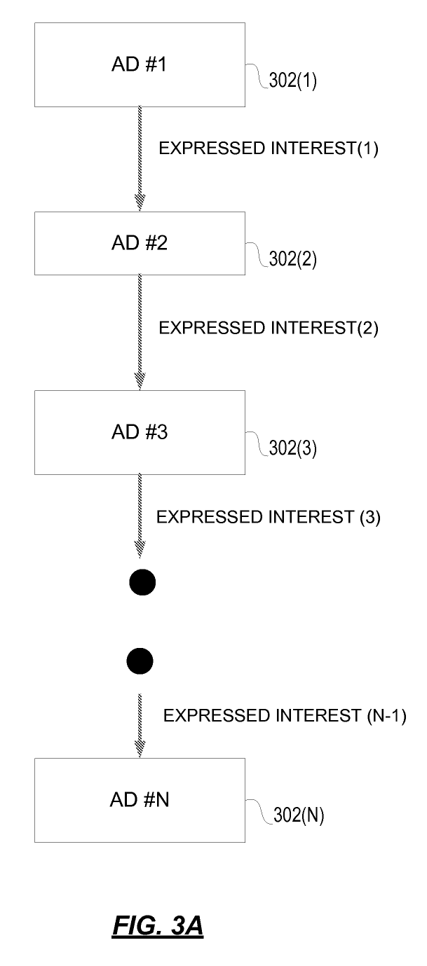

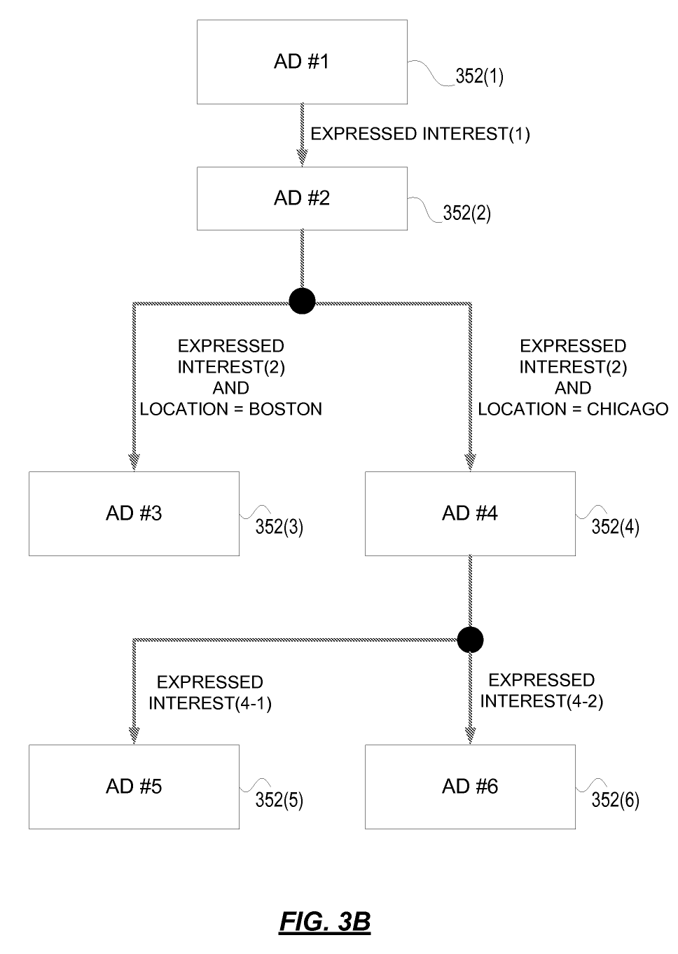

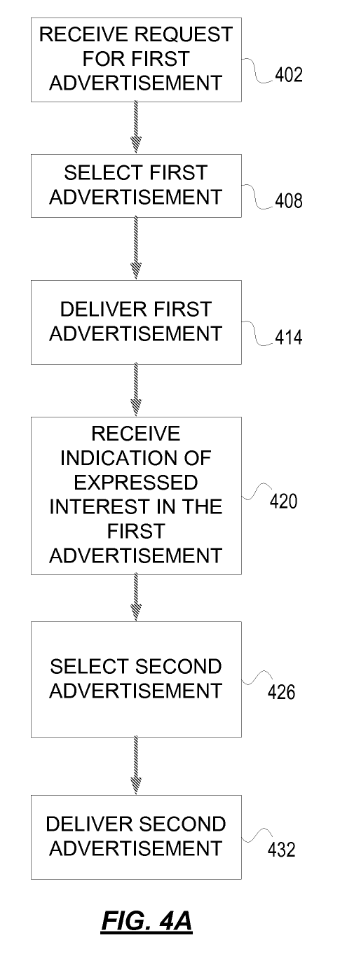

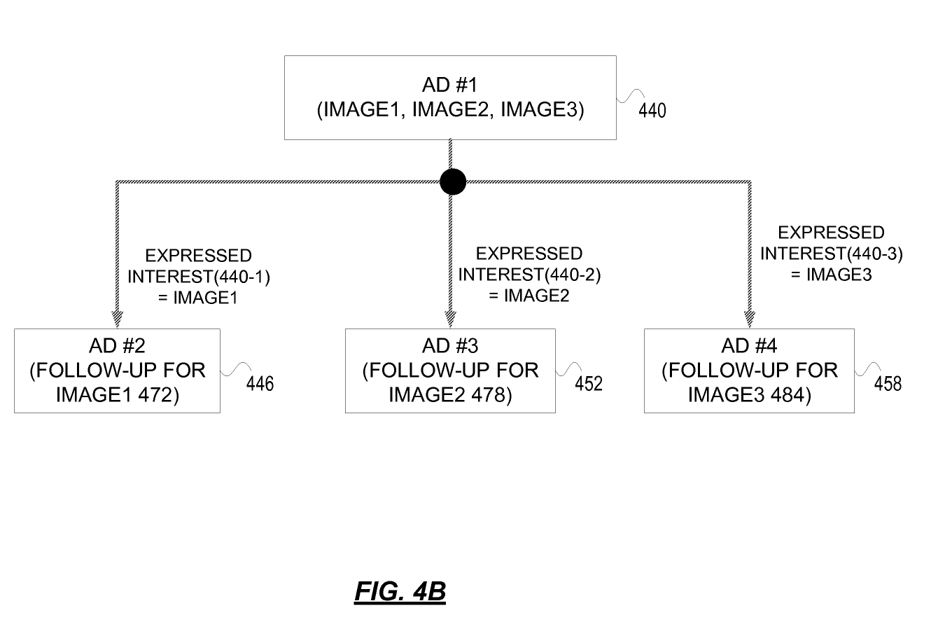

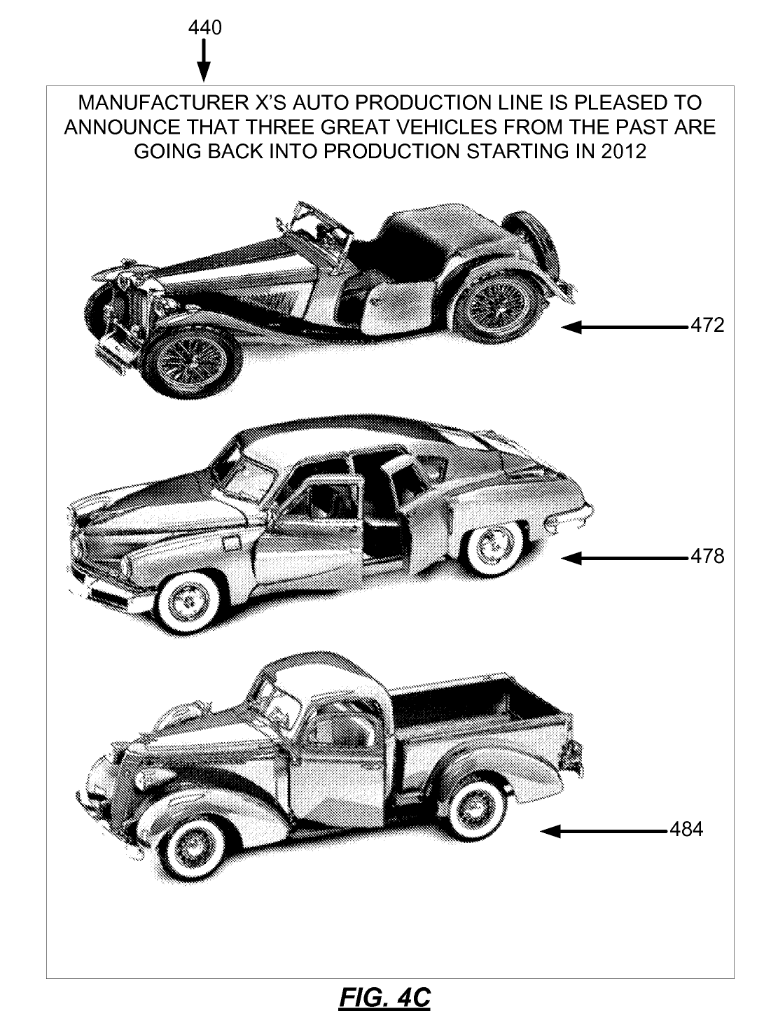

Computing environment 100, DEV1 110, DEV2 140, and device 212 are merely illustrative forms for implementing one or more aspects of the description provided herein. Computing environment 100, DEV1 110, DEV2 140, and device 212 may be arranged or configured to support linked advertisements as further described below. Advertisements may be presented to a user in a specified sequence based on one or more filtering or selection algorithms as more fully described below in relation to the hierarchical data structure of FIGS. 3A-3B and the method and use case of FIGS. 4A-4C, wherein the algorithms select a suitable advertisement for delivery and presentation at a computing device.

In terms of advertisement hierarchy or structure, one or more advertisements may be stored at a computing device and may be linked in order to support an ordered sequence of delivery. For example, when a first advertisement (ad #1) is linked to a second advertisement (ad #2), it may be implied that when a user expresses an interest in ad #1 (e.g., by clicking or selecting ad #1) that ad #2 will be delivered and displayed. Such an arrangement may be referred to as untargeted linking because the criterion that is applied to deliver and display ad #2 is an expression of interest in ad #1. As such, untargeted links might link two advertisements to one another. In an alternative arrangement, which may be referred to as targeted linking, links between advertisements may optionally support targeting parameters such that ad #2 might not always be shown responsive to an expression of interest in ad #1. Instead, the follow-up ad may be based on some predefined criterion/criteria.

The targeting parameters and/or the predefined criterion/criteria may be specified as data or metadata accompanying or included with an ad. In this manner, a level of abstraction may be maintained and the details of selection and presentation with respect to one or more advertisements may be hidden from an end user. In some embodiments, a user may be able to view or edit the data or metadata at a computing device, thereby allowing for customization by an end user. Targeting parameters will be described in greater detail below with respect to FIG. 3B.

The advertisements in the advertisement hierarchy may be referred to in familial terms. For example, ad #1 may be referred to as a parent of ad #2, and similarly, ad #2 may be referred to as a child of ad #1. Thus, in untargeted linking, a parent will have at most one child, whereas in targeted linking, a parent may have more than one child. The relationships may be further defined in accordance with customary familial terms/usage (e.g., grandparent, great grandparent, etc.)

FIGS. 3A-3B illustrate a hierarchical data structure suitable for demonstrating one or more example aspects of the invention. For example, FIG. 3A illustrates untargeted linking, which is represented as a chain or sequence of a number (N) of advertisements 302(1)-302(N). The criterion applied to transition from one advertisement to the next advertisement (represented by the connecting arrows between advertisements 302) is merely an expression of interest in the currently displayed ad.

The expression of interest may take different forms for different advertisements. Thus, in the example of FIG. 3A, expressed interest(1) associated with advertisement 302(1) may take the form of a mouse-click on a representation of advertisement 302(1), or more generally, a user explicitly selecting advertisement 302(1). Conversely, expressed interest(2) associated with advertisement 302(2) may take the form of a user viewing a representation of advertisement 302(2) for a fixed or predetermined amount of time. For example, a computing device used to display advertisement 302(2) may be equipped with gaze tracking equipment (e.g., a camera pointed at the user) and may determine that a user has expressed interest(2) when the user's gaze is fixed on advertisement 302(2) for a sufficient amount of time, thereby facilitating a transition to advertisement 302(3).

FIG. 3B illustrates untargeted linking, targeted linking, and a hybrid of untargeted linking and targeted linking. More specifically, as shown in FIG. 3B, a first advertisement 352(1) may be linked to a second advertisement 352(2), and the criterion for transitioning from first advertisement 352(1) to second advertisement 352(2) may be an expressed interest(1). As such, the transition from advertisement 352(1) to advertisement 352(2) is based on untargeted linking and is similar to the example described above with respect to FIG. 3A.

As described above, FIG. 3B also includes an illustration of targeted linking. More specifically, a transition from advertisement 352(2) to one of advertisements 352(3) and 352(4) may be based on an expressed interest(2) and a target parameter related to location. As shown, if a determination is made that a user's mobile device is located in Boston (targeting parameter location=Boston), then the transition may be made from advertisement 352(2) to advertisement 352(3) as shown. Otherwise, if a determination is made that a user's mobile device is located in Chicago (targeting parameter location =Chicago), then a transition may be made from advertisement 352(2) to advertisement 352(4) as shown. If a determination is made that the user's mobile device is not located in either Boston or Chicago, then another advertisement (potentially of more general applicability) may be delivered to the user's computing device (not shown in FIG. 3B). Location may be based on user profile information, network code, GPS or other real-time location determination, or on a user specified location.

FIG. 3B also contains an example of hybrid untargeted and targeted linking with respect to the transition from advertisement 352(4) to one of advertisements 352(5) and 352(6). As shown in FIG. 3B, the transition from advertisement 352(4) is based on an expressed interest(4), and thus falls within the definition of untargeted linking. However, the transition is dependent on how that interest is expressed (hence the usage of expressed interest(4-1) versus expressed interest(4-2)), and thus has elements of targeted linking. For example, expressed interest(4-1) may relate to a mouse-click event over a representation of advertisement 352(4), whereas expressed interest(4-2) may relate to a user viewing or staring at the representation of advertisement 352(4) beyond a threshold in terms of time.

The targeting parameters described above in conjunction with FIG. 3B related to location. Alternative targeting parameters may be included, such as genre, income group, context, recent transactions, cookies, or any other user-related parameters including short term and long term interests.

FIG. 4A illustrates a method wherein one or more example aspects of the invention may be practiced. The method of FIG. 4A is described based on the network computing environment 100 discussed above in relation to FIG. 1 and the use case scenario depicted in FIGS. 4B-4C. The method of FIG. 4A may be adapted to accommodate modifications to the network computing environment of FIG. 1 or a use case different from the one depicted in FIGS. 4B-4C without departing from the scope and spirit of the instant disclosure.

In step 402, an ad server receives a request for a first advertisement. The first advertisement may be associated with a general product or service and may be selected in accordance with one or more user preferences. For example, a user profile may indicate that the corresponding user has an interest in a given subject matter, such as automobiles. In this example, data may take on the form of a parameter such as “userprofile.interests=automobiles”. Alternatively, such data can be stored in a cookie or in a database. When the user launches a web browser on her computing device (e.g., DEV1 110 of FIG. 1), the computing device may transmit a request for an advertisement along with the other parameters to a second computing device (e.g., DEV2 140 of FIG. 1), such as an ad server, to request a first advertisement. As such, the second computing device may receive the request for the first advertisement.

In step 408, the second computing device may select an advertisement responsive to the request for the first advertisement received in step 402. For example, the second computing device may examine the parameters and/or cookies received with the request for the first advertisement and determine that the user is interested in automobiles. In response, the second computing device may select an advertisement directed to an automobile manufacturer, such as ad 440 shown in FIG. 4B. The selected advertisement may actually be stored at the second computing device, or alternatively, may be stored at another computing device (e.g., a third-party server). Moreover, the advertisement may be selected at random, or selected using an algorithm independent of the user.

In step 414, ad 440 may be delivered to the first computing device. For example, if the request of step 402 was generated responsive to the user launching a web browser on the first computing device, ad 440 may be delivered and displayed in a web browser window as a banner, a picture, a link or the like. As it relates to ad 440, ad 440 may include a collection of images wherein each image depicts a specific make or model of a car. For example, FIG. 4C shows ad 440 as including a collection of three images, image1 472, image2 478 and image3 484, representative of models of cars. Additional information, such as manufacturer's suggested retail price (MSRP), engineering specifications and the like (not shown in FIG. 4C) may be included with ad 440.

In step 420, the user of the first computing device may click with a mouse or a key or stylus or by touching screen (in case of touch screen devices) on the banner, picture, link, icon or the like associated with ad 440, or more generally, express an interest in ad 440. For example, if ad 440 was presented at the first computing device as a collection of images as shown in FIG. 4C, wherein each image depicted a specific make or model of a car, and the user expressed interest (expressed interest (440-1)=image1) in the first one of the images (e.g., image1 472) as shown in FIG. 4B, then a follow-up to image1 may be requested. Executable code associated with a click action of ad 440, image1, may cause a request for a follow-up ad to be transmitted. Additional parameters may be provided when requesting a follow-up ad. For example, in one illustrative embodiment, a phone number, user location, a home mailing address, an email address, and the like may be included as parameters. The additional types of parameters may be typed by the user as a response to a request presented by an advertisement. Alternatively, the additional types of parameters may be retrieved automatically from the first computing device from user profile information. Based on the parameters, the second computing device may take appropriate action, such as selecting a child advertisement of ad 440 in accordance with step 426 described below.

In step 426, the second computing device may select a child advertisement of ad 440 responsive to the received expression of interest with respect to ad 440, based on the click action and any additional parameters. Continuing the above example, the second computing device may select ad 446 of ad 440 in accordance with the hierarchical structure of FIG. 4B, wherein ad 446 corresponds to image1 472. If the user had expressed an interest in image2 478 (e.g., expressed interest (440-2)=image2 in FIG. 4B) in step 420, then in step 426 the second computing device may have selected ad 452 in accordance with the hierarchical structure of FIG. 4B. Similarly, if the user had expressed an interest in image3 484 (e.g., expressed interest (440-3)=image3 in FIG. 4B) in step 420, then in step 426 the second computing device may have selected second ad 458 in accordance with the hierarchical structure of FIG. 4B.

In step 432, the selected child ad of ad 440 may be delivered to the first computing device. Continuing the above example, wherein the user expressed an interest in image1 472 associated with ad 440, ad 446 may be delivered to and presented at the first computing device, and ad 446 may reference the make or model of car depicted in image1 472 that the user expressed an interest in accordance with step 420.

The method of FIG. 4A was described as having been initiated by a user launching a web browser. Additional applications may initiate the request for the first advertisement of step 402. For example, a user may instead launch an email application, and one or both of the first and second advertisements may be delivered to an email inbox. In some embodiments, the mere turning on or off of the first computing device may be sufficient to initiate requests for advertisements. In additional embodiments, passive initiators, such as a passage of time or a change in external conditions (e.g., the establishment of a car showcase located near the user) may be sufficient to initiate an acquisition of an advertisement. Other initiating conditions are within the scope of this disclosure.

Furthermore, the method of FIG. 4A was described in the context of delivering two advertisements to the first computing device. The method may be adapted to accommodate the delivery of more than two advertisements simply by extending the number of steps. Moreover, more than one advertisement may be delivered to the first computing device at approximately the same time. For example, in the context of the above example regarding advertisements of automobiles, the delivery of the child advertisement (step 432) may actually result in the delivery of advertisements of two dealers that have the model depicted in image1 472 available in stock for purchase and are located within a specified distance of one another and the first computing device. In this manner, the competing advertisements may be displayed at the first computing device, and the user of the first computing device may easily compare the terms of the offers from each of the competing dealers.

The advertisements may take on any form or combination and are not limited to images or pictures. Thus, in relation to the above example, the first advertisement delivered to the first computing device may be in the form of a collection of images as described, and the second advertisement may be in the form of a video file. More generally, one or more of the advertisements may be presented in any format including pictures, videos, audio, aural descriptions, text and/or the like, or any combination thereof, and the parameters transmitted with each request may be adapted to accommodate specific formats. For example, one or more settings associated with a user profile may express a preference for advertisements in a particular format, and the second computing device may take such preferences into consideration when selecting an advertisement responsive to the requests for advertisements.

As another example, in some embodiments when a user expresses an interest in an advertisement, a subsequent communication may be established that is different in form from the preceding examples. More specifically, when the user expressed an interest in the automobile make or model of image1 472 as described above, instead of or in addition to delivering second advertisement 446, the expression of interest in image1 472 may have initiated a telephone call to a local dealer having the model of car depicted in image1 472 in stock and available for purchase, thereby putting the user in direct contact with a salesman or customer service representative at the local dealer. Thus, more generally, an expression of interest may take the form of click-to-ad (e.g., an expression of interest in an advertisement results in the delivery of a subsequent advertisement), click-to-url (e.g., an expression of interest in an advertisement results in the delivery of a web page, email, instant message or the like), click-to-call (e.g., an expression of interest in an advertisement results in a phone call or the like being placed), or the like, wherein a subsequent communicative action takes place responsive to the expression of interest.

The nature of how an advertisement is represented at a computing device may be based on the computing device's capabilities (e.g., display type/size, browser type, connection type, memory capacity, device address, language, locale, etc.). The computing device's capabilities may be inserted as parameters when a request for an advertisement or an expression of interest is transmitted by the computing device. The advertisement may be selected based on or configured according to one or more of the device's capabilities. An illustrative interaction between a browser and a server holding a page or an ad may be obtained, wherein the server sends a cookie to the browser and the browser sends it back when requesting another page or ad, i.e., the cookie may indicate a current ad in the browser. Further, the cookies may be used to track users across a website or across multiple sites. Tracking may produce a user profile, which may be used to target advertising. Cookies may be used to track user activities such as channels visited to assist an ad server in selecting one or more appropriate advertisements. The cookie information may be sent to the ad server when an ad is requested.

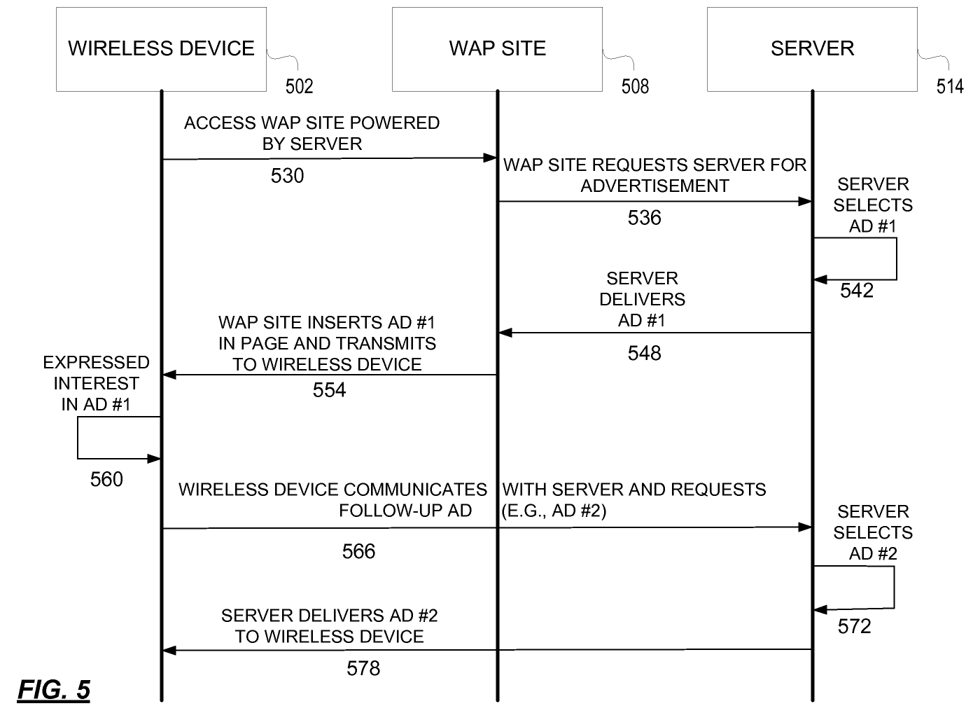

FIG. 5 illustrates a sequence diagram suitable for demonstrating one or more example aspects of this disclosure. As shown in FIG. 5, a wireless device 502 (which may be DEV 1 110 of FIG. 1 and/or device 212 of FIG. 2) may be communicatively coupled, for example, by way of Wireless Application Protocol (WAP) or Internet site/server 508, to a server 514, such as an advertisement server (which may be DEV 2 140 of FIG. 1).

In step 530, wireless device 502 may access WAP site/server 508. The nature of the access may be responsive to a request by wireless device 502 to obtain a web page or other information similar to step 402 described above with respect to FIG. 4A. In step 536, WAP site 508 may request server 514 for an advertisement. The request may be based on parameters included with the access of step 530. In step 542, server 514 may select a first advertisement (ad #1) responsive to request 536, and server 514 may deliver the first advertisement to WAP site 508 in step 548. In step 554, WAP site may insert the first advertisement into the web page, and transmit the web page—first advertisement combination to wireless device 502. Upon receipt of the web page—first advertisement combination, wireless device 502 may display or play the first advertisement. Responsive to determining that a user of the wireless device has expressed an interest in the first advertisement in accordance with step 560, wireless device 502 may communicate with server 514 in step 566. The nature of the communication in step 566 may entail a request for a follow-up advertisement (e.g., ad #2) to the first advertisement. Responsive to the communication of step 566, server 514 may select a second advertisement in step 572 and may deliver the second advertisement to wireless device 502 in step 578. Further, upon receipt of the second advertisement the wireless device 502 may display or play the second advertisement.

The architecture and sequence diagram of FIG. 5 is merely illustrative. It is understood that additional computing devices or entities may be included, and that one or more of the computing devices or entities may be removed or substituted. For example, wireless device 502 is shown in FIG. 5 as being communicatively coupled, for example, by way of Wireless Application Protocol (WAP) or Internet site/server 508, to a server 514 A hypertext transfer protocol/hypertext markup language (HTTP/HTML) based browser/site may be used in addition to, or in place of, WAP site/server 508. Other modifications are within the scope and spirit of the instant disclosure. Furthermore, in some embodiments wireless device 502 (or more generically, a computing device 502) may receive one or more advertisements and may deliver or distribute the one or more advertisements or additional (e.g., child) advertisement(s). Moreover, in some embodiments the same computing device (e.g., server 514 of FIG. 5) might not deliver both the first (e.g., parent) advertisement and the second (e.g., child) advertisement. In those embodiments, a second computing device (not shown in FIG. 5) may deliver the second (e.g., child) advertisement, or the wireless device 502 might determine which child ad to display.

Based on the foregoing description, electronic advertisements may be presented to a computing device in an ordered sequence responsive to an expression of interest and/or one or more targeting parameters. The expression of interest and one or more targeting parameters may be included in parameters and may accompany a request for an advertisement or an expression of interest. In this manner, advertisers can submit groups of related advertisements. The related advertisements may share a common group identification (group ID), and each advertisement therein may have its own individual identification (individual ID). An individual advertisement can be selected from the group based on one or more conditions (e.g., expressed interest, target parameters, and the like) that are evaluated in (substantially) real-time. For example, a group ID and an individual ID may be included in parameters. Responsive to a request for an advertisement or responsive to an expression of interest, parameters included therewith may be examined to select a particular group of advertisements that match the group ID. The individual ID may next be examined from the parameters to determine the advertisement that the user expressed an interest in, and based on a hierarchical structure similar to the ones shown in FIGS. 3A-3B, and FIG. 4B, the next (e.g., child) advertisement in the sequence may be selected (and delivered) by traversing an appropriate link from the advertisement identified by the individual ID.

In view of the description herein, advertising effectiveness may be enhanced. The more an advertisement conforms to a user's preferences or surrounding environment, the more likely it is that the user will be inclined to patronize the advertiser. Accordingly, based on a hierarchical structure of advertisements, wherein the ads bear a familial or hierarchical relationship to one another, a computing device may sequence connecting links between the ads to present an ad of increasing relevance to a user. In this manner, an ad initially may be presented at a relatively general level to appeal to as wide a target audience as possible. Thereafter, follow-up ads may be presented in an effort to appeal to a user's tastes, preferences, interests, or any other criterion.

Opportunities may exist to customize the content of an advertisement based on parameters accompanying the request for an advertisement. For example, an advertiser may submit a baseline version of an advertisement to a commercial service provider that includes a blank for an insertion of a location. The blank may be populated with location information based on a computing device's location referenced in parameters accompanying a request for an advertisement or an expression of interest in an advertisement. Thus, in this manner, the advertiser may submit a baseline version of an advertisement, and the advertisement may subsequently be tailored to the specifics of a consuming user based on information in the user-profile or information otherwise associated with the user (in this example, the consuming user's location). Advertisers thus may be able to create personalized messages or personalized offers. Advertisers may be able to save money by precluding of the need to create largely redundant advertisements. Furthermore, commercial service providers also benefit because they are not forced to store largely redundant advertisements in computing device memory.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a request for a first advertisement;
selecting a first advertisement responsive to the request for the first advertisement;
delivering the first advertisement;
receiving an expression of interest in the first advertisement, the expression of interest in the first advertisement including one or more parameters referencing the first advertisement;
selecting a child advertisement of the first advertisement based on the one or more parameters; and
delivering the child advertisement of the first advertisement.

2. The method of claim 1, wherein the selection of the first advertisement is based on a user profile.

3. The method of claim 1, wherein the selection of the child advertisement of the first advertisement is based on untargeted linking.

4. The method of claim 1, wherein the one or more parameters referencing the first advertisement include at least one target parameter.

5. The method of claim 4, wherein the at least one target parameter includes at least one of: a location of a computing device, a user demographic, a user interest, a user activity, a user transaction, and a cookie.

6. The method of claim 4, wherein the at least one target parameter customizes the child advertisement of the first advertisement.

7. The method of claim 1, further comprising:
receiving the first advertisement and the child advertisement of the first advertisement from an advertiser as a group;
storing the group as a hierarchical structure; and
establishing a link between the first advertisement and the child advertisement of the first advertisement.

8. The method of claim 7, wherein the one or more parameters referencing the first advertisement include a common group identification of the group, and wherein the one or more parameters referencing the first advertisement include an individual identification of the first advertisement, and wherein the selection of the child advertisement of the first advertisement is based on the common group identification, the individual identification of the first advertisement, and the link between the first advertisement and the child advertisement of the first advertisement.

9. The method of claim 1, wherein the request for the first advertisement is received from a user computing device.

10. The method of claim 9, wherein the selection of at least one of the first advertisement and the child advertisement of the first advertisement is based on at least one capability of the user computing device.

11. The method of claim 1, wherein at least one of the request for the first advertisement and the expression of interest in the first advertisement is received from a computing entity.

12. The method of claim 11, wherein the computing entity is at least one of a Wireless Application Protocol (WAP) site, a hypertext transfer protocol (HTTP) site, an Internet server and an executable code.

13. The method of claim 1, wherein the expression of interest in the first advertisement is based on a user explicitly selecting the first advertisement.

14. The method of claim 1, wherein the expression of interest in the first advertisement is based on a user viewing the first advertisement for a time duration that exceeds a threshold.

15. The method of claim 1, wherein the expression of interest in the first advertisement is based on a passive initiator.

16. The method of claim 1, further comprising:
receiving an expression of interest in the child advertisement of the first advertisement, the expression of interest in the child advertisement of the first advertisement including one or more parameters referencing the child advertisement of the first advertisement;
selecting a grandchild advertisement of the first advertisement based on the one or more parameters referencing the child advertisement of the first advertisement; and
delivering the grandchild advertisement of the first advertisement.

17. The method of claim 16, wherein the expression of interest is received from a user computing device.

18. An apparatus comprising:
a processor configured to:
receive a request for a first advertisement;
select a first advertisement responsive to the request for the first advertisement;
deliver the first advertisement;
receive an expression of interest in the first advertisement, the expression of interest in the first advertisement including one or more parameters referencing the first advertisement;
select a child advertisement of the first advertisement based on the one or more parameters; and
deliver the child advertisement of the first advertisement.

19. The apparatus of claim 18, further comprising a memory having stored thereon computer executable instructions executable by the processor.

20. The apparatus of claim 18, wherein the selection of the first advertisement is based on a user profile.

21. The apparatus of claim 18, wherein the selection of the child advertisement of the first advertisement is based on untargeted linking.

22. The apparatus of claim 18, wherein the one or more parameters referencing the first advertisement include at least one target parameter.

23. The apparatus of claim 22, wherein the at least one target parameter includes at least one of: a location of a computing device, a user demographic, a user interest, a user activity, a user transaction, and a cookie.

24. The apparatus of claim 22, wherein the at least one target parameter customizes the child advertisement of the first advertisement.

25. The apparatus of claim 18, wherein the processor is further configured to:
receive the first advertisement and the child advertisement of the first advertisement from an advertiser as a group;
store the group as a hierarchical structure; and
establish a link between the first advertisement and the child advertisement of the first advertisement.

26. The apparatus of claim 25, wherein the one or more parameters referencing the first advertisement include a common group identification of the group, and wherein the one or more parameters referencing the first advertisement include an individual identification of the first advertisement, and wherein the selection of the child advertisement of the first advertisement is based on the common group identification, the individual identification of the first advertisement, and the link between the first advertisement and the child advertisement of the first advertisement.

27. The apparatus of claim 18, wherein the request for the first advertisement is received from a user computing device.

28. The apparatus of claim 27, wherein the selection of at least one of the first advertisement and the child advertisement of the first advertisement is based on at least one capability of the user computing device.

29. The apparatus of claim 18, wherein at least one of the request for the first advertisement and the expression of interest in the first advertisement is received from a computing entity.

30. The apparatus of claim 29, wherein the computing entity is at least one of a Wireless Application Protocol (WAP) site, a hypertext transfer protocol (HTTP) site, an Internet server and an executable code.

31. The apparatus of claim 18, wherein the expression of interest in the first advertisement is based on a user explicitly selecting the first advertisement.

32. The apparatus of claim 18, wherein the expression of interest in the first advertisement is based on a user viewing the first advertisement for a time duration that exceeds a threshold.

33. The apparatus of claim 18, wherein the expression of interest in the first advertisement is based on a passive initiator.

34. The apparatus of claim 18, wherein the processor is further configured to:
receive an expression of interest in the child advertisement of the first advertisement, the expression of interest in the child advertisement of the first advertisement including one or more parameters referencing the child advertisement of the first advertisement;
select a grandchild advertisement of the first advertisement based on the one or more parameters referencing the child advertisement of the first advertisement; and
deliver the grandchild advertisement of the first advertisement.

35. The apparatus of claim 34, wherein the expression of interest is received from a user computing device.

36. A computer readable storage medium having stored thereon computer executable instructions that, when executed, perform:
receiving a request for a first advertisement;
selecting a first advertisement responsive to the request for the first advertisement;
delivering the first advertisement;
receiving an expression of interest in the first advertisement, the expression of interest in the first advertisement including one or more parameters referencing the first advertisement;
selecting a child advertisement of the first advertisement based on the one or more parameters; and
delivering the child advertisement of the first advertisement.

37. The computer readable storage medium of claim 36, wherein the computer executable instructions include at least one instruction that, when executed, performs:
receiving the first advertisement and the child advertisement of the first advertisement from an advertiser as a group;
storing the group as a hierarchical structure; and
establishing a link between the first advertisement and the child advertisement of the first advertisement.
